(19) United States
(12) Patent Application Publication
(10) Pub. No.: US 2006/0179736 A1
(43) Pub. Date: Aug. 17, 2006

(54) APPARATUS AND METHOD FOR RAPIDLY SECURING STORM COVERS WITH AN ATTACHMENT DEVICE AND CONCEALING THE ATTACHMENT DEVICE WHEN NOT NEEDED

(76) Inventors: Brett Bieber, Margate, FL (US); Richard Adinolfi, Coral Springs, FL (US)

Correspondence Address: JOHN C. SMITH, ESQ., 2499 GLADES ROAD, SUITE 113, BOCA RATON, FL, 33431, US

(21) Appl. No.: 11/307,609

(22) Filed: Feb. 14, 2006

Related U.S. Application Data
(60) Provisional application No. 60/593,785, filed on Feb. 14, 2005.

(51) Int. Cl. E06B 3/26

(52) U.S. Cl. 52/202

(57) ABSTRACT

A storm panel mounting system which uses a mounting bracket with sliding upper and lower rails is secured directly onto a wall. The stud bracket slidably attach to the mounting bracket allows some lateral movement of the attachment bolts which permits variances in the location of the apertures in the storm panel. Further, it provides a decorative cover that conceals the attachment bracket when the storm panels are not being used. A stud bracket slidably mounts on the upper and lower rails of the mounting bracket. The stud bracket has at least one bolt extending outward from the wall which is used to secure a storm panel with wing nuts. When not needed, the stud bracket is removed and a decorative cover replaces it. The decorative cover is also mounted on the mounting bracket by sliding it over the upper and lower rails.

### CROSS-REFERENCE TO RELATED APPLICATIONS

This application is related to, and claims the benefit of, the provisional patent application entitled “Apparatus And Method For Rapidly Securing Storm Covers With An Attachment Device And Concealing The Attachment Device When Not Needed,” filed Feb. 14, 2005, bearing U.S. Ser. No. 60/593,785 and naming Brett Bieber and Richard Adinolfi, the named inventors herein, as sole inventors, the contents of which is specifically incorporated by reference herein in its entirety.

### BACKGROUND OF THE INVENTION

1. Technical Field

The present invention relates to storm shutter systems. In particular, it relates to a permanently attached concealable securing device that allows storm covers for windows and/or doors to be rapidly attached to a structure when needed, and when not needed, to be concealed with an associated decorative cover.

2. Background

Damage from violent storms has been an ongoing problem for property owners of all types. Prior to the advance of a storm, property owners will typically secure their property by using storm panels to cover the doors and/or windows in their buildings. This typically takes a substantial amount of effort and time. In some areas, where property owners are subjected to hurricanes on a seasonal basis, they may have to go through this process several times each year.

When using storm panels fabricated from wood or plywood, property owners will normally secure the storm panels using one of several methods. They can place the storm panels over the windows or doors and then nail the edge of the panels directly to the wall of the building. The disadvantage of this approach is that installation of the storm panels damages the wall. Once the storm has passed, and the storm panels are removed, the wall will have to be repaired. Alternatively, the storm panels can be secured to bolts which were previously embedded in the wall of the building, and which protrude from the wall of the building. A problem associated with the use of embedded bolts is that the bolts create an eyesore which the property owner must live with on a daily basis. In addition, the bolts require that the attachment points on the storm panel be very carefully measured to ensure that all the bolts surrounding the window or door will align with the holes in the storm panel.

Another problem associated with storm panels is the amount of time it takes to install them. Nailing storm panels to the wall of a building is both hard work and time-consuming. Likewise, measuring and customizing storm panels so that they can be properly attached to the embedded bolts is also time-consuming and hard work.

It would be desirable to have a method of attaching storm panels to a building which would not damage the building, which would not create an undesirable appearance, and which can be rapidly installed and removed.

### SUMMARY OF THE INVENTION

The present invention provides a unique storm panel mounting system which includes a quick attachment method that allows storm panels to be attached to a building in a minimal amount of time. In addition, it uses a sliding bracket assembly that provides some lateral movement of the attachment bolts which allows compensation for variances in the location of the apertures in the storm panel. Further, it provides a decorative cover that conceals the mounting bracket when the storm panels are not being used.

The first part of the mounting system is a wall mounting bracket which is secured directly to the wall. Next there is a stud bracket, which slides over the wall mounting bracket. The wall mounting bracket includes upper and lower rails which are designed to accommodate either a stud bracket, or a decorative cover. The stud bracket slides laterally on the upper and lower rails prior to installation of the storm panel. The stud bracket has a bolt which extends outward from the building. Storm panels are mounted by placing the apertures in the storm panel over the bolts extending from a plurality of stud brackets. The storm panel is then rapidly secured with wing nuts. After the storm passes, the stud bracket is removed, along with the storm panels, and a decorative cover is installed onto the wall mounting bracket by sliding over the upper and lower rails.

### BRIEF DESCRIPTION OF THE DRAWINGS

FIG. 1A illustrates a top view of the mounting bracket which also shows the upper and lower rails and the stud bracket.

FIG. 1B illustrates a lower edge side view of the mounting bracket which also shows the lower rail and the stud bracket.

FIG. 1C illustrates an end view of the mounting bracket which also shows the upper and lower rails and the stud bracket.

FIG. 2A illustrates a top view of the stud bracket which also shows the bolt.

FIG. 2B illustrates a lower edge side view of the stud bracket which also shows the bolt.

FIG. 2C illustrates an end view of the mounting bracket which also shows the bolt and the rail clamps.

FIG. 3A illustrates a top view of a preferred embodiment of the cover bracket.

FIG. 3B illustrates a lower edge side view of a preferred embodiment of the cover bracket.

FIG. 3C illustrates a preferred embodiment of an end view of the cover bracket.

FIG. 3D illustrates optional retaining springs secured to the inside of the cover bracket.

FIG. 3E illustrates a cross-sectional view of the cover bracket secured to the mounting bracket via optional retaining springs.

FIG. 4A illustrates a top view of a preferred embodiment of the mounting bracket secured to a wall.

FIG. 4B illustrates a top view of a preferred embodiment of the stud bracket secured to the mounting bracket.

FIG. 4C illustrates a top view of a preferred embodiment of the storm panel mounted on the bolt of the stud bracket.

FIG. 4D illustrates a top view of a preferred embodiment of the storm panel secured to the bolt of the stud panel by a wing nut.

FIG. 5A illustrates a top view of an alternative referred embodiment in which the stud bracket and the mounting bracket are integrated into a single component.

FIG. 5B illustrates a side view of an alternative referred embodiment in which the stud bracket and the mounting bracket are integrated into a single component.

FIG. 5C illustrates an end view of an alternative referred embodiment in which the stud bracket and the mounting bracket are integrated into a single component.

### DESCRIPTION OF THE PREFERRED EMBODIMENT

Prior to a detailed discussion of the figures, a general overview of the system will be presented. This invention provides a unique mounting bracket system which allows storm panels to be rapidly secured to a building wall. In addition to allowing an individual with no special skills to attach storm panels in a rapid manner, the mounting bracket system also includes a decorative cover which hides the mounting bracket when storm panels are not needed.

The mounting bracket system has three components. The first component is a series of mounting brackets which are permanently secured to wall around the periphery of the opening which the property owner wants to protect. Typically, the mounting brackets are permanently attached via hardware, such as screws, nails, masonry anchors, etc. Those skilled in the art will recognize that the exact type of hardware selected will be dictated by the materials used to fabricate the wall. The advantage of permanently securing the mounting brackets to the wall is that it avoids damage to the wall which is caused by repetitively attaching and detaching the mounting brackets each time a storm occurs. In addition, by installing the mounting brackets a single time, a substantial amount of time is saved when preparing for subsequent storms.

Once the mounting brackets are permanently attached to the wall, the second component of the system is used. The second component is a stud bracket that is removably and slidably attached to the mounting bracket. The stud bracket is attached to the mounting bracket by engaging the edges of the stud bracket with upper and lower rails on the mounting bracket. The stud bracket has a bolt which extends outward from the wall and which is used to secure a storm panel. The stud bracket is slidably mounted on the mounting bracket, and because of this, it can be moved laterally to compensate for any errors which were made when mounting apertures were cut into the storm panels. After the stud brackets are attached to the mounting brackets, the storm panel is secured to the stud brackets by inserting the bolts extending from the stud brackets through apertures in the mounting panel. Then the mounting panel is secured to the stud brackets by using conventional wing nuts and washers.

The last component of the mounting system is the cover bracket, which serves an aesthetic purpose. The cover bracket is slidably attached to the mounting bracket in the same manner that the stud bracket was attached to the mounting bracket. The cover bracket can be painted so that it blends into the surrounding wall surface to avoid an unpleasant and distracting appearance. Likewise, it can be finished to provide an ornamental design which may add to the attractiveness of the building. Of course, the number of ornamental designs which are possible is only limited by the imagination of the designer.

In the preferred embodiment, each bracket is made out of galvanized steel. Galvanized steel is preferred because of its ability to withstand hostile environments. In addition, it can be easily painted to match the building color. Those skilled in the art will recognize that while galvanized steel has many desirable characteristics, any other suitable material can be substituted so long as it meets the goals and objectives of the device. Of course, while the mounting bracket in the stud bracket should be fabricated from material with a high degree of strength, such as steel, the cover bracket can be made from any suitable material since structural strength is not a factor.

An important advantage of the invention is that there are very few tools needed to install the mounting bracket system. Only a few common tools are required. In particular, the mounting bracket system can typically be installed with a drill, a screwdriver, and a tape measure. The installation steps are simple. They are as follows:

1) Measure the size of the opening (e.g., door or window) to be covered.

2) Secure the mounting brackets to the wall. Of course, the mounting brackets should always be secured with hardware appropriate for the wall in question. The mounting bracket should be secured such that the stud brackets are positioned away from the window or door opening.

3) Once the mounting brackets are secured to the wall, slide the stud brackets onto the mounting brackets. As can be seen, the stud brackets prevent the stud brackets from sliding past the end up the mounting brackets. This means that the stud brackets can only slide toward the opening in the wall.

4) If the storm panels have not previously been prepared, measure the distance between the studs on opposing stud brackets and drill apertures into the storm panel that will align with them. This step only needs to be performed once.

5) Mount the storm panel onto the stud brackets by sliding the apertures in the storm panel over the stud brackets. Then secure the storm panel to the stud brackets with flanged wing nuts. Note that in step 3, above, the stud brackets prevented the stud brackets from sliding away from the hole in the wall. When the storm panel is secured to stud brackets, the storm panel prevents the stud brackets from sliding in the opposite direction. As a result, the storm panel is held securely in one place.

6) Once the storm has passed, remove the wing nuts securing the storm panels, remove the storm panels, and then remove the stud brackets. At this time, the cover bracket can be installed by sliding it onto the upper and lower rails in the same manner that the stud bracket was installed.

As can be seen by the foregoing description, the most time required to install the mounting bracket system will be related to the first-time installation of the mounting brackets. Since the mounting brackets are installed once and remain permanently attached to the wall, the property owner does not have to be concerned with spending time on that installation step again. Typically, it is been found that the length of time for the first initial installation may take 20-30 minutes depending on the size of the opening. This time period includes all drilling, mounting, and measurements.

After the initial installation, the only thing the property owner has to do to install storm panels is to quickly remove the cover bracket, slide on the stud brackets, mount the storm panel and secure it with wing nuts. By not having to reinstall the mounting brackets, once the initial installation is done, it should take no more than 3-5 minutes per opening to put the material back onto the wall. This allows the property owner to very quickly and conveniently secure this property prior to the arrival of a storm.

In addition to the aesthetic purpose served by the cover bracket, it also provides a safety function. In particular, by concealing the mounting system hardware and any sharp edges which they may have, accidental injuries can be avoided.

Another important advantage of this invention is that anyone can install the mounting bracket system. It requires only commonly available tools, and it can be installed as a do-it-yourself installation.

Having discussed the mounting system in general, we turn now to a more detailed discussion of the figures.

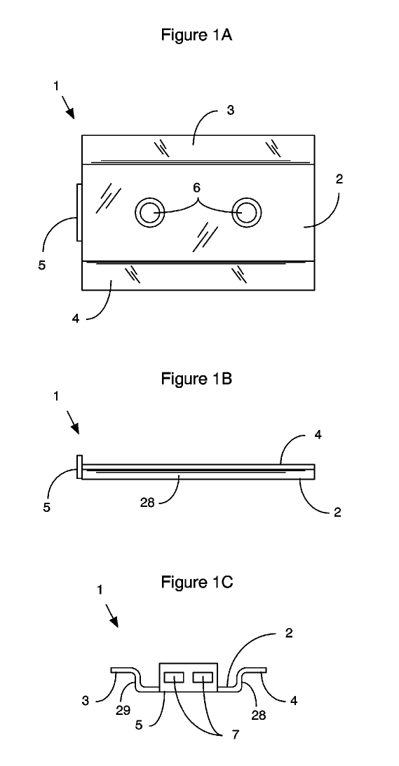

FIG. 1A illustrates a top view of a preferred embodiment of the mounting bracket 1. This view shows the first opposing side rail 3 and second opposing side rail 4. The opposing side rails 3-4 extend above the central plane 2 of the mounting bracket 1. Stop wall 5 also extends up from the surface of the central plane 2. Also shown are two screw apertures 6. In this figure, screw apertures 6 are countersunk into the surface of the central plane 2 to accommodate various types of mounting hardware. However, those skilled in the art will recognize that any suitable type of screw aperture 6 is acceptable so long as it is appropriate for the particular mounting hardware being used. Likewise, the number and position of the screw apertures 6 is not important so long as the mounting bracket 1 can be securely mounted on the wall.

FIG. 1B illustrates a lower edge side view of a preferred embodiment of the mounting bracket 1 which also shows the side rail 4 and the stop wall 5. As can be seen in this figure, stop wall 5 rises above the central plane 2. The purpose of stop wall 5 is to prevent the stud bracket 8 from sliding past the end of mounting bracket 1. In addition, side rail 4 is also shown above the level of the central plane 2. Also shown in this figure is rail wall 28 which raises the side rail 4 above the central plane 2.

FIG. 1C illustrates an end view of a preferred embodiment of the mounting bracket 1 which also shows the opposing side rails 3-4 and the stop wall 5. This figure clearly illustrates the opposing side rails 3-4 rising above the central plane 2 of mounting bracket 1. The opposing side rails 3-4 are raised above the central plane 2 by rail walls 28-29, respectively. Also shown in this figure are optional securing apertures 7 in stop wall 5. The optional securing apertures 7 can be used in conjunction with the cover bracket 15 (not shown this figure) as places to attach connectors (which may be part of the cover bracket 15) to secure the cover bracket 15.

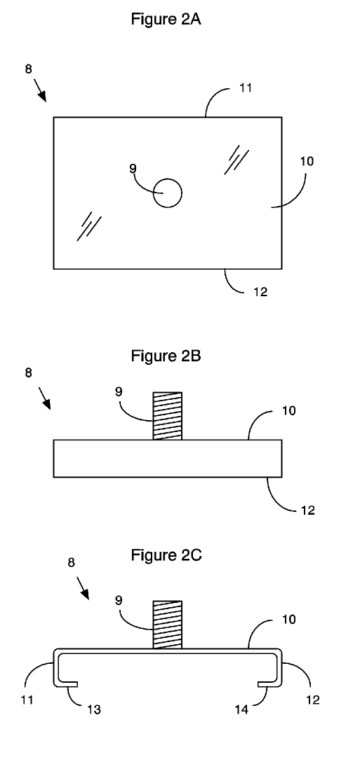

In FIG. 2, a top view of a preferred embodiment of the stud bracket 8 which also shows the bolt 9 extending upward from the stud bracket surface 10. Also shown in this figure are upper edge 11 and lower edge 12.

FIG. 2B illustrates a lower edge side view of a preferred embodiment of the stud bracket 8 which also shows the bolt 9 extending upward from the stud bracket surface 10.

FIG. 2C illustrates an end view of a preferred embodiment of the mounting bracket 8 which also shows the bolt 9 and the rail clamps 13-14. When the mounting bracket 8 is attached to mounting bracket 1, rail clamps 13-14 will slide under opposing side rails 3-4, respectively.

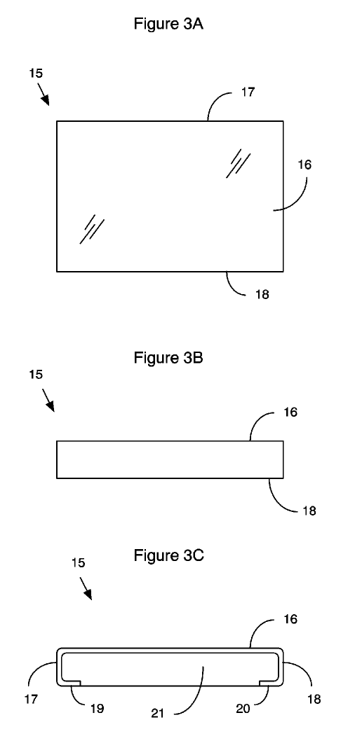

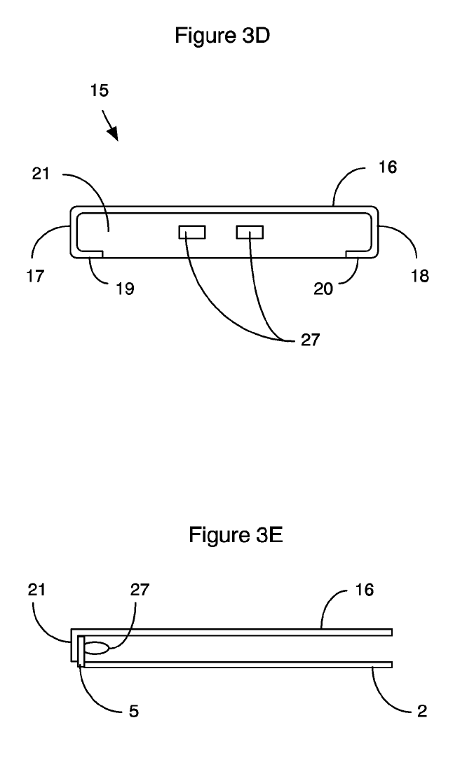

FIG. 3A illustrates a top view of a preferred embodiment of the cover bracket 15. This view also illustrates a top surface 16 of the cover bracket 15 and the upper and lower sidewalls 17-18.

FIG. 3B illustrates a lower edge side view of a preferred embodiment of the cover bracket 1. This view illustrates the top surface 16 of the cover bracket 15 and the lower sidewall 18.

FIG. 3C illustrates an end view of a preferred embodiment of the cover bracket 15. Also shown in this figure are opposing sidewalls 17-18, and cover rail clamps 19-20. In addition, end wall 21 is also shown. In the preferred embodiment, end wall 21 extends from top surface 16 to the bottom of rail clamps 19-20. This conceals the mounting bracket 1 when the cover bracket 15 is mounted onto mounting bracket 1.

In FIG. 3D, the preferred embodiment of the cover bracket 15 with optional retaining springs 27 are illustrated. The retaining springs 27 are secured to the end wall 21 of the cover bracket 15. The retaining springs 27 are intended to engage the optional securing apertures 7 in mounting bracket 1. The retaining springs 27 provided the positive retaining force to secure the cover bracket 15 to the mounting bracket 1. Those skilled in the art will recognize that alternative means of securing the cover bracket 15 to the mounting bracket 1 can be used. For example, the cover bracket 15 can be sized such that it secures to the mounting bracket 1 via friction, or any other suitable means.

FIG. 3E illustrates a side cross-sectional view of the cover bracket 15 secured to the mounting bracket 1 via optional retaining springs 27. In this embodiment, flexible retaining springs 27 are inserted through optional securing apertures 7 to secure the cover bracket 15 to the mounting bracket 1. On the cover bracket 15 is removed, the optional retaining springs 27 compress to slide through the securing apertures 7 when the cover bracket 15 is slid off of the mounting bracket 1.

Those skilled in the art will recognize that while retaining springs 27 can be used to secure the cover bracket 15 to the mounting bracket 1, any suitable means to secure the cover bracket 15 to the mounting bracket 1 can be used. For example, snap on connectors ca, hook and loop material can be used, pressure attachment, releasable adhesive, screws, etc., can all be effectively used to secure the cover bracket 15 to the mounting bracket 1.

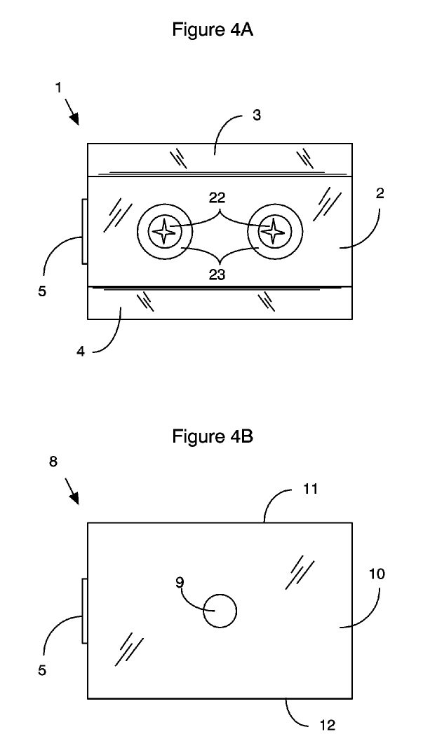

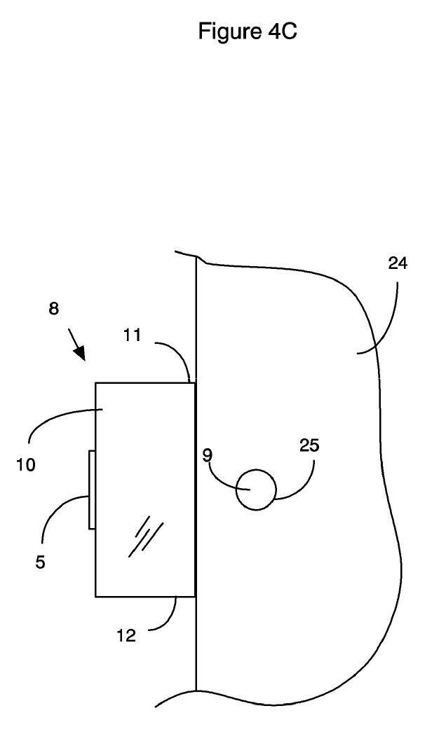

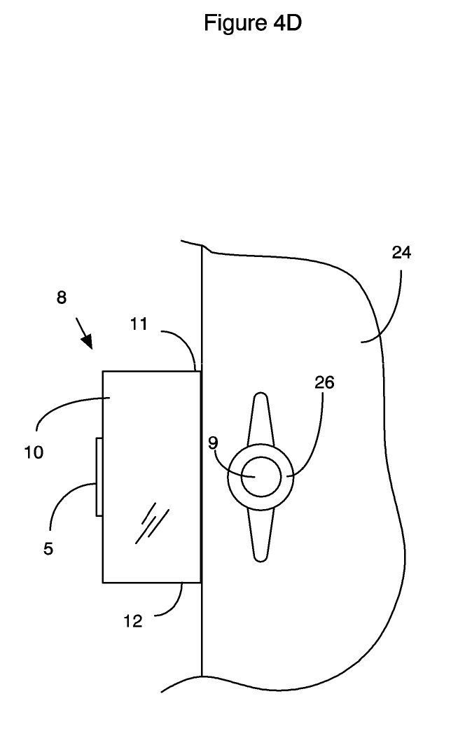

FIG. 4A illustrates a top view of a preferred embodiment of the mounting bracket 1 secured to a wall by two screws 22 and washers 23.

FIG. 4B illustrates a top view of a preferred embodiment of the stud bracket 8 secured to the mounting bracket 1. In this view, the stud bracket 8 is stopped by stud bracket 5 of mounting bracket 1.

FIG. 4C illustrates a top view of a preferred embodiment of a storm panel 24 mounted on the bolt 9 of the stud bracket 8. In this view, the aperture 25 in the storm panel 24 is shown surrounding bolt 9. As can be seen, stop wall 5 limits lateral motion of the stud bracket 8 in 1 direction while storm panel 25 limits lateral motion of the stud bracket 8 in the other direction.

FIG. 4D illustrates a top view of a preferred embodiment of the storm panel 24 secured to the bolt 9 of the stud bracket 8 by a wing nut 26. In the preferred embodiment, the bolt 9 is threaded to accommodate the wing nut 26. Those skilled in the art will recognize that any other method of securing the storm panel to the stud bracket 8 can also be used.

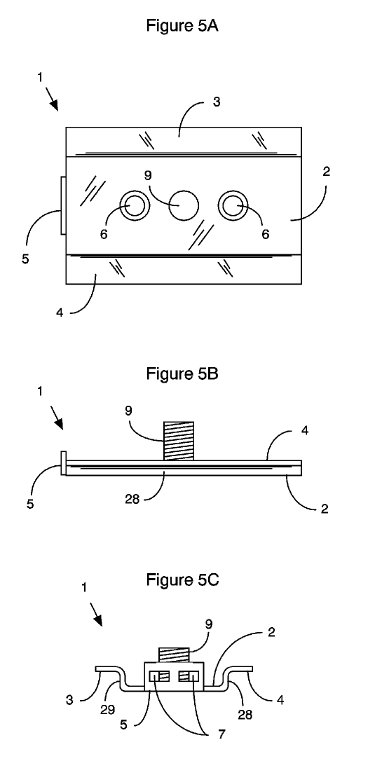

FIG. 5A illustrates a top view of alternative preferred embodiment. In this embodiment, the stud bracket 8 is eliminated and the bolt 9 from the stud bracket 8 is incorporated in to the mounting bracket 1. The advantage of this embodiment is that it eliminates one component and provides for more rapid installation storm panels 24. However, it also has a disadvantage in that it requires a larger cover bracket to accommodate the bolt 9.

FIG. 5B illustrates a side view of the alternative preferred embodiment of FIG. 5A. This figure illustrates the additional height required to accommodate the bolt 9 if it is integrated with the mounting bracket 1.

FIG. 5C illustrates an end view of the alternative preferred embodiment of FIG. 5A.

While the invention has been described with respect to a preferred embodiment thereof, it will be understood by those skilled in the art that various changes in detail may be made therein without departing from the spirit, scope, and teaching of the invention. For example, any suitable material may be used to fabricate components of the mounting bracket system. The only design limitation is that the mounting bracket system must have sufficient physical strength to secure the storm panel in a storm. The method used to secure the mounting bracket to wall may be anything suitable for its purpose, such as nails, screws, etc. Likewise, any aesthetic motif for the cover bracket may be used to suit the taste of the individual property owner.

What is claimed is:

1. A mounting bracket system for attaching a storm panel to a building, comprising:
a plurality of mounting brackets, each mounting bracket having means to permanently attach to a wall of a building near the periphery of a door, a window, or other aperture; and
each mounting bracket further having an associated stud bracket having means to removably attach to the mounting bracket, the stud bracket further having means to detachably secure a storm panel;
whereby each stud bracket is detachably secured to an associated mounting bracket, and each mounting bracket is permanently secured to a building.

2. A system, as in claim 1, further comprising:
a plurality of cover brackets, each cover bracket associated with a mounting bracket, and having means to detachably and securely attach to the associated mounting bracket when the stud bracket is attached from the mounting bracket;
whereby the cover bracket conceals the mounting bracket when the cover bracket is attached to the mounting bracket.

3. A system, as in claim 2, wherein the cover bracket is slidably mounted onto the mounting bracket and held in place via a pressure fit, via at least one screw, via releasable adhesive, or via hook and loop material.

4. A system, as in claim 2, wherein the cover bracket is slidably mounted onto the mounting bracket and held in place via a retaining device.

5. A system, as in claim 4, wherein:
the retaining device is at least one retaining spring;
the mounting bracket further comprises a securing apertures for each retaining spring; and
each retaining spring is aligned with an associated securing apertures such that, when the cover bracket is installed on the mounting bracket, each retaining spring enters the securing apertures and secures the cover bracket to the mounting bracket.

6. A system, as in claim 1, wherein:
the mounting bracket further comprises:
a central plane;
opposing side rails, each side rail attached to, and raised above, the central plane by opposing sidewalls; and
means to prevent the stud bracket from sliding past the end of the central plane when the stud bracket is mounted on the mounting bracket.

7. A system, as in claim 6, wherein:
the means to prevent the stud bracket from sliding past the end of the central plane when the stud bracket is mounted on the mounting bracket is a stop wall which extends upward from the end of the central plane toward the opposing sidewalls, the stop wall having sufficient height to prevent the stud bracket from sliding past the end of the central plane;
whereby the stud bracket can be mounted on the mounting bracket from the end of the mounting bracket which is distal to the stop wall.

8. A system, as in claim 7, further comprising a plurality of cover brackets, each cover bracket associated with a mounting bracket, and having means to detachably and securely attach to the associated mounting bracket when the stud bracket is attached from the mounting bracket.

9. A system, as in claim 8, wherein the mounting bracket further comprises at least one securing aperture; and
the cover bracket is slidably mounted onto the mounting bracket and secured by at least one retaining spring, each retaining spring is aligned with an associated securing aperture such that, when the cover bracket is installed on the mounting bracket, each retaining spring enters its associated securing aperture and secures the cover bracket to the mounting bracket.

10. A method of rapidly installing storm panels to building, including the steps of:
permanently attaching mounting brackets to the periphery of door or window openings in the wall of building;
concealing the mounting brackets with cover brackets when a storm panel is not secured to a door or window opening in the building;
removing the cover brackets prior to installing the storm panel;
attaching detachable stud brackets to the mounting brackets prior to installing the storm panel;
attaching the storm panel to each of the stud brackets by inserting a stud on the stud panel through an associated aperture on the storm panel; and
securing the storm panel to the stud bracket with a nut or wing nut.

11. A method, as in claim 10, including the additional steps of:
configuring the mounting brackets such that, when attaching the stud bracket to the mounting brackets, they can only be attached from the side of the mounting bracket closest to the door or window opening, and are prevented from passing the end of the mounting bracket which is distal from the door or window opening; and
preventing the stud bracket from sliding back toward the door or window opening by aligning the apertures in the storm panel with bolts extending from the stud panel and securing the storm panel to the bolts with wing nuts;
whereby the mounting bracket prevents the stud bracket from moving away from the door or window opening and the storm panel prevents the stud bracket from moving toward the door or window opening.

12. A method, as in claim 11, including the additional steps of:
removing the storm panel by the detaching the wing nuts and disengaging the storm panel from the stud bracket:
detaching the stud bracket from the mounting bracket; and
concealing the mounting bracket with the cover bracket.

13. A mounting bracket for attaching a storm panel to a building, comprising:
a mounting bracket having means to permanently attach to a wall of a building near the periphery of a door, a window, or other aperture; and
the mounting bracket having an associated stud bracket with means to removably attach to the mounting bracket, the stud bracket further having means to detachably secure itself to a storm panel;
whereby the stud bracket is detachably secured to the mounting bracket, and the mounting bracket is permanently secured to a building.

14. A mounting bracket, as in claim 13, further comprising:
a cover bracket having means to detachably and securely attach to the mounting bracket when the stud bracket is attached from the mounting bracket;
whereby the cover bracket conceals the mounting bracket when the stud bracket is removed and the cover bracket is attached to the mounting bracket.

15. A mounting bracket, as in claim 13, wherein:
the mounting bracket further comprises:
a central plane which is securely mounted against a surface of a building, the mounting bracket further having opposing side rails attached to the central plane by sidewalls such that the side rails are positioned away from surface of building such that stud bracket can be slidably mounted onto the side rails;
the stud bracket further comprises:
a stud bracket surface;
a bolt secured to and extending outward from the stud bracket surface;
an upper rail clamp extending outward from the stud bracket surface and shaped such that it can engage the upper rail of the mounting bracket; and
a lower rail clamp extending outward from the stud bracket surface and shaped such that it can engage the lower rail of the mounting bracket; and
a decorative cover, further comprising:
a top cover surface;
an upper rail cover clamp extending from the upper edge of the cover surface and shaped such that it can engage the upper rail of the mounting bracket; and
a lower rail cover clamp extending from the lower edge of the cover surface and shaped such that it can engage the lower rail of the mounting bracket;
whereby the stud bracket or the cover bracket can be secured to the mounting bracket.
